(19) United States
(12) Patent Application Publication
(10) Pub. No.: US 2004/0198330 A1
(43) Pub. Date: Oct. 7, 2004

(54) Method for inputting a call number in a call number memory of a telecommunication terminal, terminal and telecommunication network for carrying out said method

(76) Inventors: Jurgen Graf, Blaubeuren (DE); Cornel Klein, Oberhaching (DE)

Correspondence Address: MORRISON & FOERSTER LLP, 1650 TYSONS BOULEVARD, SUITE 300, MCLEAN, VA, 22102, US

(21) Appl. No.: 10/344,996

(22) PCT Filed: Aug. 13, 2001
(86) PCT No.: PCT/DE01/03103

(30) Foreign Application Priority Data
Aug. 21, 2000 (DE) 100407986

(51) Int. Cl. H04M 3/42

(52) U.S. Cl. 455/414.1; 455/435.1

(57) ABSTRACT

According to the inventive method, a call number is input in a call number memory of a telecommunication terminal (MS) by transmitting (S6) a call number information to the terminal (MS) via a telecommunication network (PLMN), said terminal (MS) recording a call number derived from the received call number information in a memory. The call number information can be transmitted in an especially automatic manner when the telecommunication network (PLMN detects the check-in (S1) of a terminal (MS); else, it can be transmitted upon request of the terminal (MS).

The invention relates to a method for inputting a call number into a call number memory of a telecommunications terminal, as well as to a telecommunications terminal and a telecommunications network which are suitable for carrying out the method.

Most modern telecommunications terminals, in particular those for use in mobile radio telecommunications networks, have a call number memory in which a user can enter frequently required call numbers, generally together with a name that is associated with that call number, and which can then be dialed by a short dialing key combination or by selecting the entry in the call number directory.

A series of service numbers, for example for emergencies, for breakdown assistance, or for information services, etc., are generally entered in the call number memory of a mobile radio terminal even before the terminal is passed to the end user. Generally, these call numbers are usable or worthwhile only within a restricted geographical area. Thus, a user of a mobile radio terminal, such as a mobile telephone, who is abroad, finds it unhelpful if the call number which is stored for a breakdown service in the call number directory is that for his homeland, or if the stored call number makes it possible to access only telephone information for his homeland, but not that for the country which he is currently in.

It is thus desirable to provide a method and terminals which allow a user to call specific services without any problems completely independently of his respective location, without in each case needing to know the local call numbers.

U.S. Pat. No. 5,719,929 proposes that worldwide standardized codes be assigned to specific auxiliary and emergency services such as breakdown assistance, emergency doctors, police, etc. which, when dialed on a terminal, are converted in the switching center to the appropriate local call numbers. The disadvantage of this method is that it presupposes the effectiveness of worldwide standardization of the codes, and that all the switching centers must be equipped to carry out the process of conversion of the codes to the local numbers. The investment cost that is associated with this has until now prevented the widespread introduction of the method.

WO 98/08350 discloses a method for dissemination of SMS messages to a large number of terminals which are located in the same MSC region. The SMS messages are recorded as text in a memory in the terminals.

WO 98/59506 describes a method by means of which the user of a terminal can use SMS transmission to call up information which relates to his respective location.

The object of the invention is to specify a method and a terminal which make it possible for a user to call specific services anywhere in the world without for this purpose needing to be informed of the locally applicable call numbers for those services, and without any adaptation to the switching centers being required for this purpose.

The object is achieved by the method having the feature of claim 1, as well as by the terminal having the features of claim 17 and the telecommunications network having the features of claim 19.

In the method according to the invention, a call number, in particular a service call number of the type mentioned above, is entered in a call number memory of a telecommunications terminal by call number information being disseminated in a telecommunications network, and by the terminal recording a call number, which is derived from the received call number information, in the call number memory.

This makes it possible, for example, for any operator of a mobile radio telecommunications network to disseminate a call number of a telephone information service, possibly of its own, in the telecommunications network, and each terminal according to the invention which is located within range of that telecommunications network can use the call number information disseminated in this way to extract the relevant call numbers and to record them as call numbers for a telephone information service in its call number memory. The user of a terminal such as this need only select the entry for telephone information in his call number directory in order to be connected to an appropriate information service for that network in which he is currently registered, without needing to know the actual call number for that information service.

Since, from the start, the terminal dials the locally applicable number for the service, this avoids the process of converting the call numbers within the telecommunications network, as is required according to U.S. Pat. No. 5,719,929.

A call number such as this may be disseminated periodically by transmission to all the terminals which are registered in the telecommunications network.

Terminals which enter the area of the relevant telecommunications network are supplied with the locally applicable call number by means of this very simple method at the latest when the call number information is transmitted once again.

In order to avoid continuously loading terminals which already have the locally applicable call numbers with the processing of the call number information, it is desirable to transmit the call number information specifically only to those terminals which do not have the locally applicable call numbers or for which there is at least a possibility that they do not have them. Such specific transmission can be carried out, for example, whenever a terminal registers in the telecommunications network. In this case, the call number information can be provided not only by the network in which the terminal is registered but also by a home network for the relevant terminal, if the home network is not the network in which the terminal is registered. This second variant has the advantage that it can be offered by the operator of the home network without any modification being required for this purpose to the other network in which the terminal is registered.

In addition or alternatively, call number information can also be transmitted when the telecommunications network finds that the position of the terminal has changed. Conventional mobile radio networks such as the GSM network are equipped with directories, a so-called home location register HLR and a visitor location register VLR in each case, for terminals for which the relevant mobile radio network represents a home network or some other network, in which position information is in each case stored for a terminal, in conjunction with its call number, indicating the present location of that terminal. In this case, the position resolution of this entry may be different for different mobile radio telecommunications networks, although in general it denotes at least the MSC region in which the terminal is located.

Updating of an entry in one of these registers by the mobile radio communications network which is maintaining that register may in each case result in call number information being transmitted to the relevant terminal, or being checked to determine whether the change in the position of the terminal necessitates transmission of new call number information, and in this new call number information being sent if necessary.

The call number information is preferably transmitted in the form of an SMS message. This has the advantage that no extensions whatsoever are required for the signaling protocol between the mobile radio telecommunications network and the terminal, and that no hardware changes whatsoever are required in those mobile radio networks which support SMS, in order to make it possible to use the method according to the invention.

The terminal in each case expediently uses an identifier which is transmitted with the SMS message to identify whether this message contains call number information and, if yes, records the call number which is derived from it. This identifier may, for example, comprise a specific symbol or a symbol sequence in the SMS message. A symbol such as this or a symbol sequence such as this may be agreed as standard between a large number of network operators, so that each network in which the relevant terminal is located can adapt the call numbers stored in the terminal in a simple manner. It is also possible to use the sender call number of the SMS message as the identifier. This variant has the advantage that it means that no changes whatsoever are required to the SMS protocol.

The method according to the invention can be used not only for updating a call number which has already previously been recorded in the call number memory, but also for a completely new entry of such a call number. A completely new entry may arise, for example, when a terminal is used for the first time and no call numbers whatsoever have yet been stored in it. In a situation such as this, the initial registration of the terminal in a network leads to the new entry of the call numbers which correspond to the call number information transmitted in that network. For the network operator, this means that the previously normal process of entering possibly operator specific service call numbers before the terminals are issued to the users can be avoided, thus saving costs.

The network operator may, however, also use the capability for new entry to enter newly introduced services in the course of the life of the terminals or else, for example, to enter the telephone numbers of commercial concerns who are interested in making contact with the users of the terminals. The updating process may include the replacement of a call number by a new call number, for example in the case of the number of a breakdown service, where this is desirable when necessary, by always storing the number of that service which is located closest to the current location of the terminal; however, the change may also include a change to the dialing code of the stored call number of the service. For example, for a user who is located in a foreign country and does not understand the language in that country, it may be more expedient to call his national telephone information service than to call a local telephone information service in the country in which he is located. This is made possible according to the invention by the terminal adding a suitable country dialing code to the stored call number on receiving appropriate call number information. A procedure such as this is, of course, not just worthwhile for the call numbers for individual services but, in particular, also for call numbers of preferred call partners who are entered in the directory by the user.

Exemplary embodiments will be explained in more detail in the following text with reference to the drawings, in which:

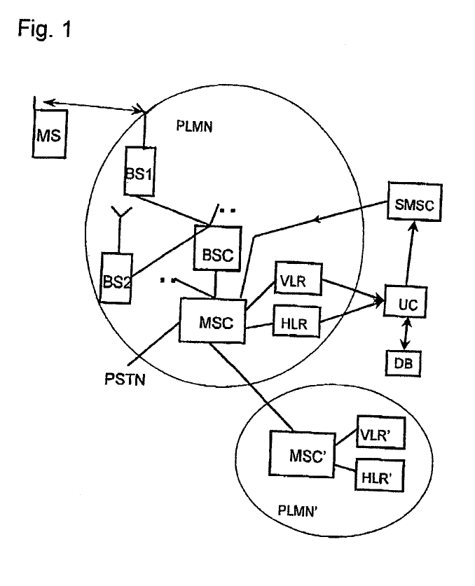

FIG. 1 shows a schematic block diagram of a mobile radio network in which the present invention can be used;

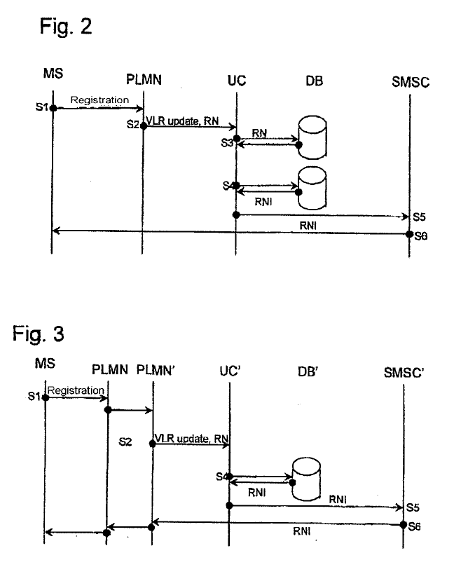

FIG. 2 shows the signaling between the mobile radio network and the terminal according to a first refinement of the method;

FIG. 3 shows the signaling between the mobile radio system and the terminal according to a second refinement of the method; and

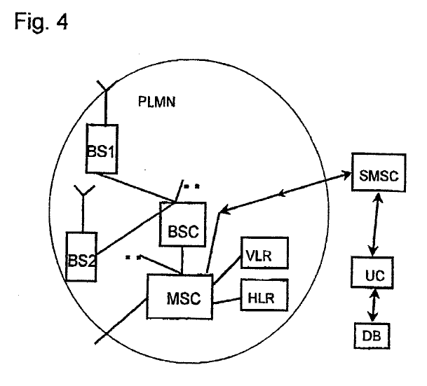

FIG. 4 shows a block diagram of a mobile radio system for carrying out a further refinement of the method.

FIG. 1 shows the structure of a telecommunications network PLMN, to be more precise of a GSM radio communications system, in which the method according to the invention can be used. The telecommunications network PLMN has a large number of mobile switching centers MSC, only one of which is illustrated in the figure, but which are networked to one another and produce access to other networks, such as a landline network PSTN and a second radio communications system, PLMN′. Furthermore, these mobile switching centers MSC are each connected to at least one base station controller BSC. Each base station controller BSC in turn allows a connection to be set up to at least one base station BS. A base station BS such as this can set up a message connection V1, V2, Vk to subscriber stations MS1, MS2, . . . , MSk, . . . , via a radio interface.

The telecommunications network PLMN furthermore has two directories, the so-called home location register HLR and the visitor location register VLR, in which information which is required for administration of the mobility of the individual mobile terminals is stored. The mobile switching centers MSC in the radio communications system may be associated individually or in groups with a respective home location register or visitor location register.

An updating control unit UC (Update Controller) is connected to the two registers HLR and VLR and in this way receives updating information relating to the location of individual terminals, which is sent from the mobile switching center MSC to one of the two registers HLR or VLR. The updating control unit UC is furthermore connected to a call number databank DB and to an SMS center SMSC, which is able to send SMS messages via the mobile switching center MSC to the terminals in the radio communications network PLMN or other networks.

A second mobile radio communications network PLMN′ has the same components as the network PLMN described above. The same reference symbols are used for the components in this network as for the network PLMN, but followed by an apostrophe. For reasons of simplicity, the components of the network PLMN′ are not all shown in the figures.

A first method for updating service call numbers in a terminal, and which can be carried out with the network PLMN, will now be described with reference to FIG. 2.

When a terminal MS registers in the network PLMN in step S1, then this leads in a manner known per se to the recording or updating of an entry, which relates to this terminal MS, in the directory VLR for that network. A message which is signaled to the directory VLR for this purpose contains information about the location of the terminal MS, together with information which identifies that terminal, such as its IMSI or its call number. An identical message is transmitted to the updating control unit UC, in step S2.

If the terminal is not located in the network PLMN but in a second network such as PLMN1, an appropriate message is also passed to the directory VLR′ for the home network PLMN′, where information is stored relating to the location of the terminal in the network PLMN.

In step S3, the updating control unit UC checks a data record, which is stored in the databank DB when the same terminal MS previously registered, and which contains information about the location of the terminal at the time of the previous registration. If this location information matches that received in step S2, it is assumed that the call numbers which are stored in the terminal SM are suitable for its current location, and the method ends. If the location information is different, or if there is no entry relating to the terminal MS in the databank DB, then it is assumed that the location of the terminal MS has been changed, and that call numbers which are stored in it will no longer necessarily be suitable for the current location in which it is being used.

Instead of directing the question in step S3 to the databank DB, the updating control unit UC could also direct the question to the directory VLR, although, to do so, it is necessary either for the updating control unit UC to receive the updating message which identifies the new location for the terminal MS earlier than the directory VLR, so that an earlier location of the terminal can still be checked from the directory VLR before this is overwritten on the basis of the updating message; or the directory VLR must be adapted such that, after the directory VLR has received the updating message, the location information relating to an earlier location of the terminal can still be checked from the directory VLR.

It is also possible to omit the step S3 and thus to carry out the next step S4 whenever a terminal registers, irrespective of whether or not its location has changed.

In step S4, the updating control unit UC checks call number information RNI from the databank DB, specifying one or more service call numbers which are applicable to the location of the terminal MS as can be determined from the position information. This call number information RNI is transmitted in step S5 to the SMS center SMSC, which collates it in order to form an SMS message or—if more call numbers are intended to be transmitted than can be transmitted in the limited length of one SMS message—to form a number of SMS messages, which is or are transmitted to the terminal MS via the network PLMN in step S6.

The way in which the SMS message is evaluated by the terminal MS will be described later.

The first method described above is applicable not only to terminals which have the network PLMN as their home network but also to those whose home network is another network, such as PLMN′. The position information which the updating control unit UC requires can thus in the simplest case be restricted to the network association of the respective terminal. In a situation such as this, an SMS message which contains call number information is in each case produced for those terminals which are registered and whose home network is not the network PLMN. These terminals thus receive an SMS message whenever they register, specifying, for example, the numbers applicable in that network PLMN for emergency calls, telephone information, etc. The terminals whose home network is the network PLMN receive a message such as this only when the comparison process carried out in step S3 indicates that, in the meantime, they have been registered in some other network, so that there is a risk that stored call numbers may have been overwritten while they were located in the other network, and now need to be updated once again.

Greater resolution of the position information makes the method attractive for various other call numbers. If, for example, the position information makes it possible to identify the town in which the terminal is located at a given time, then it may be valuable for a user of the terminal if the call numbers of a local taxi service, of the nearest dealership for his motor vehicle, of restaurants, theatre or cinema card reservation services or the like, for example, are automatically entered in his call number directory, using the method described above, in any town that he is visiting.

A second method which can be used for a terminal which is registered in some other network will be described with reference to FIG. 3. In this case, it is assumed that the network PLMN′ is the home network of the terminal which is registered in the network PLMN in step S1. During the registration process, the network PLMN passes a message (in a manner which is known per se) to the home network PLMN′, including the identity of the registering terminal MS, and information about its location. The network PLMN′ notes this information in its home location register HLR′. The same message is transmitted to the updating control unit UC′ in the network PLMN′, which then checks the call number information stored in the databank DB′ relating to the position information. The call number information which is checked from the databank DB′ is passed in step S5 to the SMS center SMSC′, which then sends an SMS message with the call number information to the relevant terminal MS.

The special feature of this second method is that control of the change to telephone numbers in the directory of the terminal MS remains with its home network and is not transferred to the other network in whose area the terminal MS is currently located. A procedure such as this may be necessary in circumstances in which different network operators use different formats for SMS messages containing call number information and the terminal MS is located in the area of a network whose format cannot be processed by it. Furthermore, this second method can also be used when, although the other network in which the terminal MS is located supports SMS messages, it is not able to produce SMS messages with call number information for automatic call number updating.

When the terminal MS returns later to the area of its home network PLMN′, then the home network can change the amended call numbers back using the first method as described above: registration in the home network PLMN′ leads to a change to the entry corresponding to that terminal MS in the register VLR′. On the basis of the change to the entry, the network PLMN′ identifies that there is a requirement for call number updating, and carries out steps S2 to S6 as described with reference to FIG. 2.

In the simplified mobile radio network as shown in FIG. 4, the connection between the updating control unit UC and the directory VLR or HLR is omitted.

Instead of this, the SMS center SMSC is connected via a bidirectional connection to the mobile switching center MSC, and it also communicates bidirectionally with the updating control unit UC.

In this network, the call numbers which are stored in a terminal MS are updated using a third method, by the user of the terminal sending an SMS message to the SMS center SMSC, by means of which it identifies its wish for call number updating. This SMS message may include position information entered by the user in the terminal, but it can also be added to, in a similar way to that in the case of the methods described with reference to FIGS. 2 and 3, by position information which is provided automatically by the network. The message also contains the call number of the sending terminal.

The SMS center SMSC transmits the position information contained in the message to the updating control unit UC, which then checks the databank DB in the same way as that described for step S4 with reference to FIGS. 2 and 3. The production of a response SMS message with the call number information supplied from the databank DB by the SMSC and the transmission of the SMS message to the terminal MS take place in the same way as that described above with reference to FIGS. 2 and 3, with the SMSC defining the recipient of the response message, which contains the call number information, on the basis of the sender call number which is transmitted with the requesting message.

The methods which have been described so far each use SMS messages which have been addressed specifically to a specific terminal, in order to supply this with updated call numbers. In addition to the addressing of SMS messages to individual terminals, mobile radio networks also offer the capability, however, to send such messages to all the terminals which are registered in that network, the so-called cell broadcast. This functionality of the mobile radio networks can also be used according to a fourth method according to the invention for call number updating. In this method, which can likewise be used in a network having the structure shown in FIG. 4, the SMS messages which contain the call number information are not in each case sent once on registration of a terminal with the network, but are sent to all the terminals at regular intervals (for example once per minute) by means of a cell broadcast.

One advantage of the third and of the fourth method is that no modification to the HLR or VLR directories is required for their use in mobile radio networks which are already in operation, and they can thus be carried out with little investment in the network infrastructure.

A terminal such as a mobile telephone which is suitable for use of the method according to the invention has, in a manner known per se, a memory, at least a part of which, which is located on the SIM card of the mobile telephone or in the mobile telephone itself, is intended for storing call numbers. A further part of the memory can be used for storing received SMS messages. Normally, all the SMS messages received by the mobile telephone are kept in this second memory area at least until a user has read them.

In addition to this, a terminal according to the invention has a processor, which investigates incoming SMS messages for the presence or absence of a predetermined identification character. An identification character such as this may, for example, be a specific character or symbol or a specific character or symbol sequence within the message block of an SMS message; however, the call number of the sender, which is likewise transmitted as part of the SMS message, is preferably used as such an identification character.

When the processor finds the identification character in an SMS message, then this SMS message is not necessarily stored as text in the second memory area, but is processed directly by the processor, which extracts the transmitted call numbers from the message and enters or overwrites the call numbers that in each case correspond to them in the call number memory of the mobile telephone.

There are a number of possible ways for producing unique correspondence between the stored numbers and the numbers contained in the call number information in the SMS message.

A first possibility is for those call numbers in the call number memory of the mobile telephone which are intended to be capable of being overwritten by SMS messages to in each case be permanently allocated predetermined memory locations in the call number memory, and for the SMS message in each case to contain call number information which corresponds to all these call numbers in the sequence of their memory locations. For example, it is possible to stipulate that the first ten memory locations in the call number memory are intended to be capable of being overwritten by call numbers which are transmitted in an SMS message, and of these memory locations, by way of example, for the first to be permanently associated with a general emergency call number, the second with the police, the third with the fire service, the fourth with a rescue service, the fifth with telephone information, etc. In a corresponding way to the associated sequence, the SMS message successively contains updated telephone numbers for emergency calls, for the police, for telephone information, etc., which just need to be transferred to the call number memory on the basis of the sequence in which they occur in the message.

It is also feasible not to overwrite all the call numbers which can be overwritten, but only to overwrite selected call numbers with an SMS message in each case; in this case, for example, the corresponding call numbers in the mobile telephone can be updated, for example, with the aid of an SMS message which indicates only one updated police call number and the associated memory location 2; the other call numbers which intrinsically can be overwritten but which were not mentioned in the SMS message remain unchanged.

A further possibility, instead of transmitting a memory location number in the SMS message, is to transmit that name in connection with which the call number is indicated to a user of the mobile telephone when searching through the call number directory. In a situation such as this, the decoder unit searches the call number directory for the identification contained in the SMS message, and overwrites the call number which may be found there corresponding to this identification with the call number mentioned in the SMS message. A procedure such as this has the following advantage for the user: if he wishes to ensure that a call number which can intrinsically be overwritten has not been changed in his directory, then, by changing the identification associated with that call number, he can ensure that this is not associated with call number information on reception of an SMS message, and thus also that it cannot be changed. Specifically, this means that, if a user wishes to ensure that, for example, the stored telephone information number is not automatically changed when he registers in another network abroad, then he can replace a “telephone information” identification, which was originally possibly preset by the home network operator, by, for example, “telephone information in Germany”, thus ensuring that an SMS message which transmits a new call number in conjunction with the identification “telephone information” cannot be associated with any entry in his call number directory. This may lead to the mobile telephone ignoring the SMS message although, alternatively, it is also possible to provide for a call number to be stored in conjunction with the transmitted identification at a memory location which until then has been free in the call number directory.

A further development of the method described above allows the scope of the updating of call numbers to be matched to the respective requirements and way of life of the users This may be done for all of the method variants described above by in each case storing a subscriber profile in the updating control unit UC, which indicates those call numbers which are to be updated when a change in position is detected for that particular subscriber.

Furthermore, in the third method, which provides for the SMS message that contains the call number information to be checked by means of a requesting SMS message from the terminal MS to the SMSC, it is possible for the requesting SMS message to specify the numbers to be updated. This may be achieved, for example, by the user displaying the call number directory on his mobile telephone and marking in the directory those entries which he wishes to have updated, in response to which the memory location numbers or designations that correspond to the marked entries are automatically included in the requesting SMS message that is produced by the terminal.

In addition, call numbers which have so far not been included in the call number directory in the mobile telephone can be transmitted and recorded from new selectively. For example, this makes it possible for the mobile telephone not only to offer for updating call numbers that are already stored in the call number directory but, furthermore, various generic designations such as “hotels”; “restaurants”, “motor vehicle repair shops” or the like as well. If the user selects one or more of these designations, the SMSC adds to the SMS message intended for him those call numbers which are recorded in the databank DB for the relevant generic designation relating to the user's current location.

In addition to call numbers, the databank DB may also contain information of general interest, in particular tourism interest, relating to the possible locations, and this is transmitted automatically or on request by the user to his mobile telephone when the call numbers are updated. This transmission may be in the form of a second SMS message, which is separate from the SMS message containing the call number information and which is stored in the second memory area in the conventional manner by the terminal. The information may also be transmitted as part of the message containing the call number information, in which case the processor then breaks down this message into a part containing the call number information and a text part containing the general information, with the part containing the call number information being used as described above for updating stored telephone numbers, and the text part being stored in the same way as a conventional SMS message.

1. A method for inputting a call number into a call number memory of a telecommunications terminal (MS), characterized in that call number information (RNI) is disseminated in a telecommunications network (PLMN), and the terminal (MS) records a call number, which is derived from the received call number information (RNI), in a memory.

2. The method as claimed in claim 1, characterized in that the call number information (RNI) is disseminated by periodic transmission to all the terminals (MS) which are registered in the telecommunications network (PLMN).

3. The method as claimed in claim 1, characterized in that the call number information (RNI) is disseminated by specific transmission to the terminal (MS) when that terminal registers in the telecommunications network (PLMN).

4. The method as claimed in claim 3, characterized in that the telecommunications network (PLMN) sends the call number information (RNI) to a registering terminal (MS) for which it is not the home network.

5. The method as claimed in claim 3, characterized in that, whenever a terminal (MS) registers in a controlling telecommunications network (PLMN) which is not its home network, the home network (PLMN′) transmits the call number information (RNI) to the terminal (MS) via the controlling network (PLMN).

6. The method as claimed in one of claims 3 to 5, characterized in that the call number information (RNI) is transmitted when the telecommunications network (PLMN) finds that the position of the terminal (MS) has changed.

7. The method as claimed in claim 6, characterized in that the telecommunications network maintains a directory (HLR; VLR) of the locations of the connected terminals, and finds that the position of a terminal (MS) has changed when an entry relating to the terminal in the directory (HLR;VLR) is changed.

8. The method as claimed in one of claims 3 to 5, characterized in that the call number information (RNI) is transmitted on request by the terminal (MS).

9. The method as claimed in one of the preceding claims, characterized in that the call number information (RNI) is transmitted to the terminal (MS) in the form of one or more SMS messages.

10. The method as claimed in claim 9, characterized in that the terminal (MS) uses an identifier which is transmitted with the SMS message to identify that the SMS message contains call number information (RNI), and records the call number which is derived from this message.

11. The method as claimed in claim 10, characterized in that the identifier is the sender call number of the SMS message.

12. The method as claimed in one of the preceding claims, characterized in that said method is used for updating a call number which has already previously been recorded in the call number memory.

13. The method as claimed in claim 12, characterized in that the updating process includes the replacement of the stored number by a new number.

14. The method as claimed in claim 12, characterized in that the updating process includes a change to the dialing code of the stored number.

15. The method as claimed in one of claims 1 to 11, characterized in that said method is used for new-recording of a call number.

16. The method as claimed in one of the preceding claims, characterized in that said method is used for inputting at least one of the following call numbers;
an information service,
an emergency service.

17. A terminal for a telecommunications network having a call number memory, characterized by a processor for extracting call numbers from messages which are sent by the telecommunications network to the terminal, and for recording the extracted numbers in the call number memory.

18. The terminal as claimed in claim 17, characterized in that the processor extracts the call numbers from received SMS messages.

19. A telecommunications network, characterized by a databank (DB) which, for a given service, in particular an emergency service or an information service, contains call numbers which differ regionally within the telecommunications network, and/or at least one number for the service which is applicable in another telecommunications network, and by a device (SMSC, UC) for transmitting call numbers from the databank to a telecommunications terminal (MS).

20. The telecommunications network as claimed in claim 19, characterized in that the device (SMSC, UC) for transmitting call numbers has a device for producing SMS messages (SMSC).
